(19) United States
(12) Patent Application Publication
(10) Pub. No.: US 2025/0137774 A1
(43) Pub. Date: May 1, 2025

(54) THREE-DIMENSIONAL SCANNING METHOD AND SYSTEM

(71) Applicant: Shining3D Tech Co., Ltd., Hangzhou (CN)

(72) Inventors: Xiaobo ZHAO, Hangzhou (CN); Wenbin WANG, Hangzhou (CN)

(73) Assignee: Shining 3D Tech Co., Ltd., Hangzhou (CN)

(21) Appl. No.: 18/969,075

(22) Filed: Dec. 4, 2024

Related U.S. Application Data
(63) Continuation-in-part of application No. 17/264,309, filed on Jan. 29, 2021, now abandoned.

(30) Foreign Application Priority Data
Aug. 1, 2018 (CN) 201810860030.8

(51) Int. Cl. G01B 11/25; G06T 7/521; G06T 7/55; G06T 17/00; H04N 23/13; H04N 23/56

(52) U.S. Cl. CPC G01B 11/2518; G06T 7/521; G06T 7/55; G06T 17/00; H04N 23/13; H04N 23/56; G06T 2200/08; G06T 2207/10028; G06T 2207/10152; G06T 2210/56

(57) ABSTRACT

A three-dimensional scanning system is provided. The three-dimensional scanning system is configured to obtain the three-dimensional data of a scanned object. The three-dimensional scanning system includes a scanner, including a projection module and a collecting module, wherein the projection module is configured to project scanning light to the scanned object, and the collecting module includes a first collecting apparatus and a second collecting apparatus. The first collecting apparatus is configured to obtain the three-dimensional data of features of a surface of the scanned object, the second collecting apparatus is configured to obtain the three-dimensional point cloud data of the surface of the scanned object, and the three-dimensional data of the features includes the three-dimensional data of mark points and/or the three-dimensional data of key features.

This application is a continuation-in-part application of U.S. patent application Ser. No. 17/264,309 filed on Jan. 29, 2021 which is a continuation application of International Application No. PCT/CN2019/098201 filed on Jul. 29, 2019 and claims priority under 35 U.S.C. § 119 from Chinese Patent Application No. 201810860030.8 filed on Aug. 1, 2018. The entire subject matter of each of the applications is incorporated herein by reference.

### TECHNICAL FIELD

The present disclosure relates to the field of three-dimensional digitization, and in particular to a three-dimensional scanning method and system.

### BACKGROUND

With the development and maturity of digital image processing, digital projection display, and computer processing technology, three-dimensional scanning technology has developed rapidly. A three-dimensional scanning system may project structured light to a surface of an object, a camera device captures an image projected by the structured light, and three-dimensional size information of the surface of the object is reconstructed using a three-dimensional reconstruction algorithm according to the shape of the captured image.

Traditionally, the three-dimensional scanning system uses the same set of cameras to simultaneously identify mark points and a modulated reconstruction pattern, and completes the splicing of the modulated reconstruction pattern after splicing with the mark points. However, in order to ensure the accuracy of a three-dimensional model, the above three-dimensional scanning system needs to paste enough mark points, resulting in many holes in the final data that need to be filled later.

### SUMMARY

Embodiments of the present disclosure provide a three-dimensional scanning method and system, which may ensure the details of scanned data and improve the scanning accuracy in a case of reducing the usage amount of mark points.

Some embodiments of the present disclosure provide a three-dimensional scanning system, configured to obtain the three-dimensional data of a scanned object. The three-dimensional scanning system includes a scanner.

The scanner includes a projection module and a collecting module. The projection module is configured to project scanning light to the scanned object, and the collecting module includes a first collecting apparatus and a second collecting apparatus. The first collecting apparatus is configured to obtain the three-dimensional data of features of a surface of the scanned object, the second collecting apparatus is configured to obtain the three-dimensional point cloud data of the surface of the scanned object, and the three-dimensional data of the features includes three-dimensional data of mark points and three-dimensional data of key features, or three-dimensional data of mark points, or three-dimensional data of key features.

In some embodiments, the first collecting apparatus is arranged for collecting rough image information of the surface of the scanned object within a first scanning range, the second collecting apparatus is arranged for collecting precise image information reflected by the scanned object within a second scanning range, the precise image information is obtained based on a reconstruction pattern, the rough image information is used for determining the three-dimensional data of the mark points, the precise image information is configured to determine the point cloud data, and multiple pieces of the point cloud data are spliced based on the three-dimensional data of the mark points to obtain complete the three-dimensional data of the scanned object.

In some embodiments, the three-dimensional scanning system further includes at least one fixed projector, configured to be fixed to a preset position relative to the scanned object. The scanner is configured to be movable relative to the scanned object, the fixed projector is configured to project a feature image of a first waveband to the scanned object, the projection module is configured to emit scanning light of a second waveband to the surface of the scanned object, the feature image includes multiple key features, the first collecting apparatus is configured to collect the feature image projected to the scanned object, and obtain the three-dimensional data of the key features projected to the surface of the scanned object, and the second collecting apparatus is configured to collect the scanning light of the second waveband reflected by the scanned object, and obtain the dense three-dimensional point cloud data of the surface of the scanned object. The first waveband does not interfere with the second waveband.

In some embodiments, the second scanning range is smaller than the first scanning range.

In some embodiments, a collecting range of the first collecting apparatus at least partially overlaps with a collecting range of the second collecting apparatus.

In some embodiments, the scanner includes a housing, the projection module, the first collecting apparatus, and the second collecting apparatus are arranged in the housing, and the scanner further includes a gripping part arranged on the scanner.

In some embodiments, the first collecting apparatus further includes a first illumination piece and a first optical filter of a first waveband. The first illumination piece is annularly arranged around each external collecting component, and the first illumination piece is configured to project light of the first waveband to illuminate mark points on the surface of the scanned object, and the first optical filter is arranged at a front end of the external collecting component, and the first optical filter is configured to retain incident light of the first waveband and filter out incident light of other wavebands. The second collecting apparatus includes a second optical filter of a second waveband. The second optical filter is arranged at a front end of an internal collecting component, and the second optical filter is configured to retain incident light of the second waveband and filter out incident light of other wavebands. The first waveband is different from the second waveband.

In some embodiments, the projection module includes a first projection module and a second projection module. The first projection module is configured to project a reconstruction pattern of a first waveband, and the second projection module is configured to project a reconstruction pattern of a second waveband. The first collecting apparatus further includes a first illumination piece and a first optical filter of the first waveband. The first illumination piece is annularly arranged around each external collecting component, and the first illumination piece is configured to project light of the first waveband to illuminate the mark points on the surface of the scanned object, and the first optical filter is arranged at a front end of the external collecting component, and the first optical filter is configured to retain incident light of the first waveband and filter out incident light of other wavebands. The second collecting apparatus further includes a second illumination piece and a second optical filter of a second waveband. The second illumination piece is annularly arranged around an internal collecting component, and the first illumination piece and the second illumination piece are configured to project light of the second waveband to illuminate the mark points on the surface of the scanned object, and the second optical filter is arranged at a front end of the internal collecting component, and the second optical filter is configured to retain incident light of the second waveband and filter out incident light of other wavebands. The first collecting apparatus is configured to collect the mark points and a modulated reconstruction pattern of the first waveband of the scanned object. The second collecting apparatus is configured to collect the mark points and a modulated reconstruction pattern of the second waveband of the scanned object.

In some embodiments, the projection module includes a first projection module and a second projection module. The first projection module is configured to project a reconstruction pattern of a first waveband to the scanned object in a first time period, and the second projection module is configured to project a reconstruction pattern of a second waveband to the scanned object in a second time period. A scanner body further includes a first illumination piece and a second illumination piece. The first illumination piece is annularly arranged around each external collecting component, and the second illumination piece is annularly arranged around an internal collecting component, and the first illumination piece and the second illumination piece are configured to illuminate mark points on the surface of the scanned object. The first collecting apparatus is configured to collect the mark points and a modulated reconstruction pattern of the scanned object in the first time period. The second collecting apparatus is configured to collect the mark points and the modulated reconstruction pattern of the scanned object in the second time period.

In some embodiments, the projection module includes a dual-frequency projector. The dual-frequency projector is configured to project a reconstruction pattern of a first waveband in a first time period, and the dual-frequency projector is configured to project a reconstruction pattern of a second waveband in a second time period. A scanner body further includes a first illumination piece and a second illumination piece. The first illumination piece is annularly arranged around each external collecting component, and the second illumination piece is annularly arranged around an internal collecting component, and the first illumination piece and the second illumination piece are configured to illuminate the mark points on the surface of the scanned object. The first collecting apparatus 210 is configured to collect the mark points and a modulated reconstruction pattern of the scanned object in the first time period. The second collecting apparatus is configured to collect the mark points and the modulated reconstruction pattern of the scanned object in the second time period.

In some embodiments, the projection module includes a projector. The projector is configured to project a reconstruction pattern to the scanned object in a second time period. A scanner body further includes a first illumination piece and a second illumination piece. The first illumination piece is annularly arranged around each external collecting component, and the first illumination piece is configured to project light to the scanned object in a first time period to illuminate the mark points on the surface of the scanned object. The second illumination piece is annularly arranged around an internal collecting component, and the first illumination piece and the second illumination piece are configured to project light to the scanned object in the second time period to illuminate the mark points on the surface of the scanned object. The first collecting apparatus is configured to collect the mark points of the scanned object in the first time period. The second collecting apparatus is configured to collect the mark points and a modulated reconstruction pattern of the scanned object in the second time period.

In some embodiments, the first collecting apparatus includes a first collecting component and a second collecting component, and the second collecting apparatus includes a third collecting component. The third collecting component is arranged between the first collecting component and the second collecting component. The projection module is arranged between the third collecting component and the first collecting component, or the projection module is arranged between the third collecting component and the second collecting component.

In some embodiments, the first collecting apparatus includes a first collecting component and a second collecting component, and the second collecting apparatus includes a third collecting component and a fourth collecting component. The third collecting component and the fourth collecting component are both arranged between the first collecting component and the second collecting component, and the projection module is arranged between the third collecting component and fourth collecting component.

In some embodiments, the three-dimensional data of the key features and the dense three-dimensional point cloud data synchronously collected by the first collecting apparatus and the second collecting apparatus are unified into single data in the same coordinate system.

In some embodiments, the three-dimensional scanning system further includes a controller. The controller is in communication connection with the scanner, and the controller is configured to establish a three-dimensional model of the scanned object according to the three-dimensional point cloud data of the scanned object.

In some embodiments, the three-dimensional scanning system further includes a controller. The controller is in communication connection with the projector, and the controller controls the projector to project a corresponding feature image according to scanning requirements.

In some embodiments, the three-dimensional scanning system further includes a fixing apparatus corresponding to the projector. The fixing apparatus fixes the corresponding projector to a preset position around the scanned object.

In some embodiments, when the three-dimensional scanning system includes multiple fixed projectors, multiple fixed projectors are arranged at intervals in a preset manner.

In some embodiments, the three-dimensional scanning system further includes a moving apparatus. The scanner is arranged on the moving apparatus, and the moving apparatus drives the scanner to move relative to the scanned object.

Embodiments of the present disclosure further provide a three-dimensional scanning method, configured to obtain the three-dimensional data of a scanned object and applied to a three-dimensional scanning system. The three-dimensional scanning method includes: projecting a reconstruction pattern to the scanned object; and collecting image information reflected by the scanned object, where the image information is obtained based on the reconstruction pattern, the image information is used for obtaining the three-dimensional point cloud data of the scanned object.

In some embodiments, the operation of projecting the reconstruction pattern to the scanned object includes: projecting a feature image of a first waveband to the scanned object, where the feature image includes multiple key features; and emitting scanning light of a second waveband to a surface of the scanned object. The second waveband is different from the first waveband.

In some embodiments, the operation of collecting the image information reflected by the scanned object, the image information is obtained based on the reconstruction pattern, the image information is used for obtaining the three-dimensional point cloud data of the scanned object includes: collecting the feature image projected to the scanned object, and obtaining the three-dimensional data of key features projected to the surface of the scanned object; and collecting the scanning light of the second waveband reflected by the scanned object, and obtaining dense three-dimensional point cloud data of the surface of the scanned object.

In some embodiments, the three-dimensional data of the key features and the dense three-dimensional point cloud data are synchronously collected, the three-dimensional data of the key features and the dense three-dimensional point cloud data synchronously collected are unified into single data in the same coordinate system, and a three-dimensional model of the scanned object is established based on multiple pieces of the single data.

In some embodiments, the three-dimensional scanning method includes: performing rigid body transformation on common key features among the pieces of the single data, and splicing residuals and performing non-linear least square method iterative optimization to complete a high accuracy of global optimization and reduce an accumulated error of the pieces of the single data.

The three-dimensional scanning system provided by the embodiments of the present disclosure is configured to obtain the three-dimensional data of the scanned object. The three-dimensional scanning system includes the scanner, including the projection module and the collecting module. The projection module is configured to project the scanning light to the scanned object, and the collecting module includes the first collecting apparatus and the second collecting apparatus. The first collecting apparatus is configured to obtain the three-dimensional data of the features of the surface of the scanned object, the second collecting apparatus is configured to obtain the three-dimensional point cloud data of the surface of the scanned object, and the three-dimensional data of the features includes three-dimensional data of mark points and three-dimensional data of key features, or three-dimensional data of mark points, or three-dimensional data of key features. According to the present disclosure, the rough image information of the scanned object collected by the external collecting component is used to assist in the splicing of the point cloud data corresponding to the precise image information, so that the complete three-dimensional data of the scanned object is obtained, and in a case of reducing the usage amount of the mark points, holes that need to be filled later in the point cloud data may be reduced or even eliminated, the details of the scanned data may be ensured, and the scanning accuracy may be improved.

### BRIEF DESCRIPTION OF THE DRAWINGS

FIG. 1a is a schematic diagram of a first architecture of a three-dimensional scanning system according to an embodiment of the present disclosure.

FIG. 1b is a schematic diagram of a second architecture of a three-dimensional scanning system according to an embodiment of the present disclosure.

FIG. 1c is a schematic diagram of a third architecture of a three-dimensional scanning system according to an embodiment of the present disclosure.

FIG. 2 is a schematic diagram of a fourth architecture of a three-dimensional scanning system according to an embodiment of the present disclosure.

FIG. 3 is a schematic diagram of a first application environment of a three-dimensional scanning system according to an embodiment of the present disclosure.

FIG. 4 is a schematic diagram of a second application environment of a three-dimensional scanning system according to an embodiment of the present disclosure.

FIG. 5 is a flowchart of a three-dimensional scanning method according to an embodiment of the present disclosure.

FIG. 6 is a schematic structural diagram of a three-dimensional scanning system according to an embodiment of the present disclosure.

FIG. 7 is a schematic structural diagram of a computer device according to an embodiment of the present disclosure.

### DETAILED DESCRIPTION OF EMBODIMENTS

In order to facilitate the understanding of the present disclosure, and make the purposes, features and advantages of the present disclosure clearer, the specific implementations of the present disclosure will be described below in detail in combination with the drawings. In the following description, many specific details are described in order to fully understand the present disclosure, and preferred implementations of the present disclosure are given in the drawings. However, the present disclosure may be implemented in various different forms and is not limited to the implementations described herein. On the contrary, the purpose of providing these implementations is to make the understanding of the present disclosure more thorough and comprehensive. The present disclosure can also be implemented in other ways different from those described here, and those skilled in the art may make similar extensions without departing from the meaning of the present disclosure. Therefore, the present disclosure is not limited by the specific embodiments disclosed below.

It is to be noted that terms “first”, “second” and the like in the description, claims and the above drawings of the present disclosure are used for distinguishing similar objects rather than describing a specific sequence or a precedence order. It should be understood that the data used in such a way may be exchanged where appropriate, in order that the embodiments of the present disclosure described here can be implemented in an order other than those illustrated or described herein. In addition, terms “include” and “have” and any variations thereof are intended to cover non-exclusive inclusions. For example, it is not limited for processes, methods, systems, products or devices containing a series of steps or units to clearly list those steps or units, and other steps or units which are not clearly listed or are inherent to these processes, methods, products or devices may be included instead.

Unless otherwise defined, all technical and scientific terms used herein have the same meaning as commonly understood by those skilled in the art of the present disclosure. The terms used in the specification of the present disclosure are for the purpose of describing the specific embodiments and are not intended to limit the present disclosure. The term “and/or” used herein includes any and all of combinations of one or more of the associated listed items.

FIG. 2 is a schematic diagram of a three-dimensional scanning system according to an embodiment of the present disclosure. As shown in FIG. 2, the three-dimensional scanning system includes a fixed projector 10, a scanner 20, and a controller 30.

The fixed projector 10 is configured to be fixed to a preset position relative to a scanned object, the scanner is configured to be movable relative to the scanned object, the fixed projector 10 is configured to project a feature image of a first waveband to the scanned object 60, and the feature image includes multiple key features.

Optionally, the fixed projector 10 is configured to project the feature image of the first waveband to the scanned object 60. Specifically, the first waveband may be any one of a visible light waveband and an invisible light waveband. In some embodiments, the first waveband is the invisible light waveband. As one optional example, the first waveband is a waveband of 815 nm to 845 nm in the invisible light waveband. Further, the feature image of the first waveband adopts a specific wavelength, and the wavelength is 830 nm.

The three-dimensional scanning system further includes a fixing apparatus 40 corresponding to the fixed projector 10. Optionally, the fixing apparatus 40 fixes the corresponding fixed projector 10 to a preset position around the scanned object 60. Specifically, the fixing apparatus 40 can fix the corresponding fixed projector 10 at any suitable position on a wall, a bracket or other objects, as long as the fixed projector 10 may project the feature image of the first waveband to the scanned object 60. The fixing apparatus 40 can stabilize the fixed projector 10 to avoid shaking of the fixed projector 10, so that the feature image of the first waveband projected by the fixed projector 10 is more accurate, so as to improve the scanning accuracy.

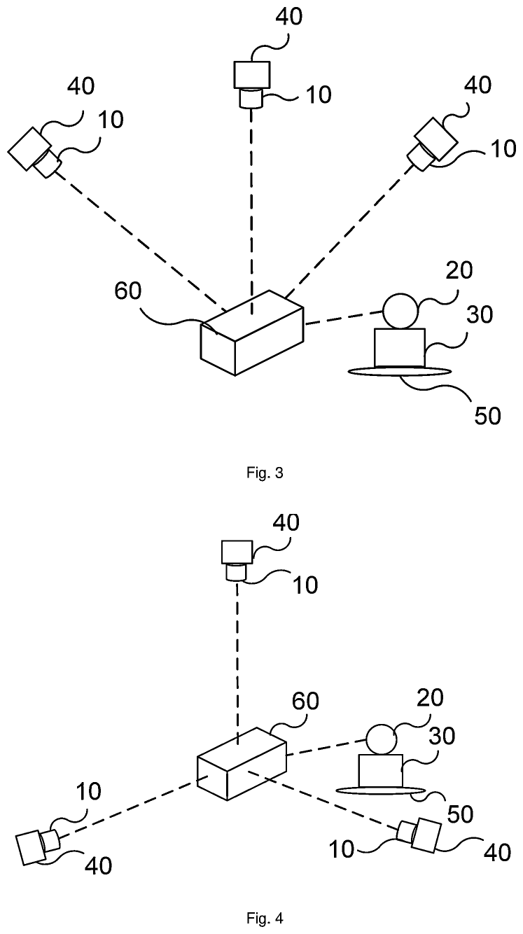

Optionally, when the three-dimensional scanning system includes multiple fixed projectors, multiple fixed projectors are arranged at intervals in a preset manner. In some embodiments, as shown in FIG. 3, the fixed projectors 10 are arranged around the scanned object 60 along a spatial arc. It is understandable that the fixed projectors 10 may also be distributed on a spatial spherical surface. In another optional embodiment, as shown in FIG. 4, the fixed projectors 10 are distributed around the scanned object 60 along different coordinate positions of a spatial three-dimensional rectangular coordinate system. Of course, there may be one fixed projector, as long as an area to be scanned of the scanned object can be covered with a projection area of the projector.

In some embodiments, the feature images of the first waveband, projected by multiple fixed projectors 10, are collected by one scanner 20.

The scanner 20 includes a projection module 230, a first collecting apparatus 210 corresponding to the fixed projector 10, and a second collecting apparatus 220 corresponding to the projection module.

The projection module 230 is configured to emit scanning light of a second waveband to a surface of the scanned object 60. Specifically, the second waveband may be any one of a visible light waveband and an invisible light waveband. In some embodiments, the second waveband is the visible light waveband. As one optional example, the second waveband is a waveband of 440 nm to 470 nm in the visible light waveband. Further, the scanning light of the second waveband adopts a specific wavelength, and the wavelength is 455 nm.

Optionally, the first waveband projected by the fixed projector 10 does not interfere with the second waveband emitted by the scanner.

In some embodiments, the projection module includes a dual-frequency projector. The dual-frequency projector is configured to project a reconstruction pattern of a first waveband in a first time period, and project a reconstruction pattern of a second waveband in a second time period. A scanner body further includes a first illumination piece and a second illumination piece. The first illumination piece is annularly arranged around each external collecting component, and the second illumination piece is annularly arranged around an internal collecting component, and the first illumination piece and the second illumination piece are configured to illuminate the mark points on the surface of the scanned object. The first collecting apparatus 210 is configured to collect the mark points and a modulated reconstruction pattern of the scanned object in the first time period. The second collecting apparatus 220 is configured to collect the mark points and the modulated reconstruction pattern of the scanned object in the second time period.

In some embodiments, the external collecting component and the internal collecting component are cameras.

In some embodiments, the projection module includes a first projection module and a second projection module. The first projection module is configured to project a reconstruction pattern of a first waveband to the scanned object in a first time period, and the second projection module is configured to project a reconstruction pattern of a second waveband to the scanned object in a second time period. A scanner body further includes a first illumination piece and a second illumination piece. The first illumination piece is annularly arranged around each external collecting component, and the second illumination piece is annularly arranged around an internal collecting component, and the first illumination piece and the second illumination piece are configured to illuminate the mark points on the surface of the scanned object. The first collecting apparatus is configured to collect the mark points and a modulated reconstruction pattern of the scanned object in the first time period. The second collecting apparatus is configured to collect the mark points and the modulated reconstruction pattern of the scanned object in the second time period.

The collecting module includes the first collecting apparatus and the second collecting apparatus. The first collecting apparatus 210 collects the feature image of the first waveband for obtaining the three-dimensional data of features of the surface of the scanned object, and the second collecting apparatus 220 collects the scanning light reflected by the second waveband for obtaining the three-dimensional point cloud data of the surface of the scanned object. The wavebands collected by the first collecting apparatus 210 and the second collecting apparatus 220 are not prone to interference, so that the collected three-dimensional data is more accurate.

The first collecting apparatus 210 is configured to collect the feature image projected to the scanned object 60, obtain the three-dimensional data of the key features projected to the surface of the scanned object, and send the collected three-dimensional data of the key features to the controller 30. The collection of the first collecting apparatus 210 is not interfered by the scanning light of the second waveband.

The second collecting apparatus 220 is configured to collect the scanning light of the second waveband reflected by the scanned object 60, obtain the dense three-dimensional point cloud data of the surface of the scanned object, and send the collected dense three-dimensional point cloud data to the controller 30. The collection of the second collecting apparatus 220 is not interfered by the feature image of the first waveband.

The first collecting apparatus 210 is arranged for collecting rough image information of the surface of the scanned object within a first scanning range, the second collecting apparatus 220 is arranged to be within a second scanning range, which is smaller than the first scanning range, and collect precise image information based on the reconstruction pattern reflected by the scanned object.

The complete three-dimensional data of the scanned object is obtained according to the rough image information and the precise image information. The scanning range of the camera may be configured in four manners. (1) By arranging different focal lengths, different scanning ranges of the first collecting apparatus and the second collecting apparatus are achieved. The larger the focal length, the larger the scanning range. A difference between the specific focal lengths of the first collecting apparatus 210 and the second collecting apparatus 220 may be determined according to the features of the scanned object 60. (2) By arranging different Charge Coupled Device (CCD) sizes, different scanning ranges of the first collecting apparatus 210 and the second collecting apparatus 220 are achieved. (3) By arranging arrangement positions of the cameras in the first collecting apparatus 210 and the second collecting apparatus 220, different scanning ranges of the first collecting apparatus 210 and the second collecting apparatus 220 are achieved. (4) When the arrangement positions of the cameras in the first collecting apparatus 210 and the second collecting apparatus 220 are fixed, different scanning ranges of the first collecting apparatus 210 and the second collecting apparatus 220 may be achieved by adjusting arrangement angles of the cameras in the first collecting apparatus 210 and the second collecting apparatus 220. In actual work, scanners with different scanning ranges may be configured according to different applications, and the scanning ranges of the first collecting apparatus 210 and the second collecting apparatus 220 may be configured together in one or more of the four manners. The specific configuration manner is not limited in the embodiments of the present disclosure, as long as the second scanning range is smaller than the first scanning range.

It is to be noted that the second scanning range and the first scanning range have an overlapping area. Preferably, the first scanning range completely covers the second scanning range.

The scanning range of the first collecting apparatus 210 is larger than that of the second collecting apparatus 220. The rough image information is obtained by the first collecting apparatus 210, the rough image information may include mark point information and/or the modulated reconstruction pattern of the scanned object, and the precise image information may include the mark point information and/or the modulated reconstruction pattern of the scanned object. Since the first scanning range of the first collecting apparatus 210 is larger than the second scanning range of the second collecting apparatus 220 and the first scanning range and the second scanning range have the overlapping area, when the first collecting apparatus 210 and the second collecting apparatus 220 scan the same scanned object, the single scanning area of the first collecting apparatus 210 on the scanned object needs to scan the second collecting apparatus 220 for many times, multiple pieces of the point cloud data obtained according to the multi-frame precise image information collected by the second collecting apparatus 220 through multiple scans correspond to the relevant data obtained according to the rough image information collected by the first collecting apparatus 210 through the single scan, and then the distribution relationship between multiple pieces of the point cloud data may be determined based on the relevant data obtained by the first collecting apparatus 210, that is, the accurate splicing of multiple pieces of the point cloud data may be completed based on the relevant data obtained by the first collecting apparatus 210. Specifically, the rough image information includes the mark points, and the precise image information includes the reconstruction pattern modulated by the surface of the scanned object. Three-dimensional data of a first mark point is obtained according to the rough image information, and multiple pieces of second point cloud data are obtained according to the precise image information. Multiple pieces of the second point cloud data are spliced according to the three-dimensional data of the first mark point, and the scanned object is accurately spliced through multiple pieces of the point cloud data.

The second collecting apparatus 220 includes at least two cameras, and the first collecting apparatus 210 includes at least one camera.

In some embodiments, the first collecting apparatus 210 includes multiple external collecting components, and the second collecting apparatus 220 includes at least one internal collecting component. The first collecting apparatus 210 further includes a first illumination piece of a first waveband and a first optical filter of the first waveband. The first illumination piece is annularly arranged around each external collecting component, and the first illumination piece is configured to project light of the first waveband to illuminate the mark points on the surface of the scanned object 60, and the first optical filter is arranged at a front end of the external collecting component, and the first optical filter is configured to retain incident light of the first waveband and filter out incident light of other wavebands. The second collecting apparatus 220 further includes a second illumination piece of a second waveband and a second optical filter of the second waveband. The second illumination piece is annularly arranged around each internal collecting component, and the second illumination piece is configured to project light of the second waveband to illuminate the mark points on the surface of the scanned object 60, and the second optical filter is arranged at a front end of the internal collecting component, and the second optical filter is configured to retain incident light of the second waveband and filter out incident light of other wavebands. The projection module 230 includes a first projection module of the first waveband and a second projection module of the second waveband. The first projection module projects the reconstruction pattern of the first waveband to the scanned object 60, the second projection module is configured to project the reconstruction pattern of the second waveband to the scanned object 60, and the reconstruction pattern is an ordinary stripe pattern, a speckle pattern, or a sinusoidal stripe pattern. Preferably, the reconstruction pattern of the first waveband and the reconstruction pattern of the second waveband are both ordinary stripe patterns. The stripe density distribution of the ordinary stripe pattern of the first waveband and the ordinary stripe pattern of the second waveband may be the same or different. Preferably, the stripes of the ordinary stripe pattern of the first waveband are distributed relatively sparsely, so that the first collecting apparatus with the larger scanning range can identify and extract the stripes. The stripes of the ordinary stripe pattern of the second waveband are distributed relatively densely, so that more point cloud data may be obtained. In this embodiment, the first waveband is different from the second waveband, which ensures that when light of multiple wavebands exists synchronously, the first collecting apparatus and the second collecting apparatus may synchronously collect the light of corresponding wavebands without collecting interference light of other wavebands. For example, when the first illumination piece, the first projection module, the second illumination piece, and the second projection module synchronously project the light to the surface of the scanned object, and the external collecting component and the internal collecting component synchronously collect light, the external collecting component collects the light of the first waveband projected by the first illumination piece and the first projection module without collecting the light of the second waveband projected by the second illumination piece and the second projection module, and the internal collecting component collects the light of the second waveband projected by the second illumination piece and the second projection module without collecting the light of the first waveband projected by the first illumination piece and the first projection module.

The scanner of this embodiment may be configured with one or more of the following operating modes. One of the configurations is selected to perform a scan according to the scanning requirements. During scanning, the scanner operates corresponding operating components or modules according to the operating mode.

In a first operating mode, the first illumination piece irradiates the light of the first waveband to the surface of the scanned object, the first projection module synchronously projects the reconstruction pattern of the first waveband to the surface of the scanned object relative to the first illumination piece, the mark points are pasted on the surface of the scanned object, the light and the reconstruction pattern of the first waveband are reflected by the surface of the scanned object and collected by the external collecting component, and the external collecting component collects the rough image information including the mark points and the modulated reconstruction pattern; the second illumination piece irradiates the light of the second waveband to the surface of the scanned object, the second projection module synchronously projects the reconstruction pattern of the second waveband to the surface of the scanned object relative to the second illumination piece, the light and the reconstruction pattern of the second waveband are reflected by the surface of the scanned object and collected by the internal collecting component, and the internal collecting component synchronously collects the precise image information including the mark points and the modulated reconstruction pattern relative to the external collecting component; and the complete three-dimensional data of the scanned object is obtained based on the collected rough image information and precise image information. Specifically, the three-dimensional data of the first mark point is reconstructed based on the mark points of the rough image information, the first point cloud data is reconstructed based on the modulated reconstruction pattern of the rough image information, the three-dimensional data of a second mark point is reconstructed based on the mark points of the precise image information, the second point cloud data is reconstructed based on the modulated reconstruction pattern of the precise image information, a first transformation matrix is determined based on the splicing of multiple pieces of the three-dimensional data of the first mark point, and the first point cloud data and the second point cloud data are spliced based on the first transformation matrix, so as to obtain the complete three-dimensional data of the scanned object.

The operation that the first point cloud data and the second point cloud data are spliced based on the first transformation matrix specifically includes: splicing multiple pieces of the first point cloud data based on the first transformation matrix, and splicing the first point cloud data and the second point cloud data based on the first transformation matrix and calibrated external parameters of the first collecting apparatus 210 and the second collecting apparatus 220; or, splicing multiple pieces of the first point cloud data based on the first transformation matrix, determining a second transformation matrix based on the splicing of the three-dimensional data of the first mark point and the three-dimensional data of the second mark point, and splicing the first point cloud data and the second point cloud data based on the second transformation matrix, so that the external parameters of the external collecting component and the internal collecting component do not need to be calibrated.

In this embodiment, for the first point cloud data and the second point cloud data, whether the first point cloud data or the second point cloud data is retained or not may be selected according to the curvature, so as to achieve adaptive retention of feature details of the data, thereby reducing the data volume on the basis of ensuring the data details.

In a second operating mode, the first illumination piece irradiates the light of the first waveband to the surface of the scanned object in the first time period.

The first projection module projects the reconstruction pattern of the first waveband to the surface of the scanned object in the first time period, the mark points are pasted on the surface of the scanned object, the light and the reconstruction pattern of the first waveband are reflected by the surface of the scanned object and collected by the external collecting component in the first time period, and the external collecting component collects the rough image information including the mark points and the modulated reconstruction pattern; the second illumination piece irradiates the light of the second waveband to the surface of the scanned object in the second time period, the second projection module projects the reconstruction pattern of the second waveband to the surface of the scanned object relative in the second time period, the light and the reconstruction pattern of the second waveband are reflected by the surface of the scanned object and collected by the internal collecting component in the second time period, the first time period and the second time period are different time periods, and the internal collecting component collects the precise image information including the mark points and the modulated reconstruction pattern in a time-sharing manner relative to the external collecting component; and the complete three-dimensional data of the scanned object is obtained based on the collected rough image information and precise image information, specifically, the three-dimensional data of the first mark point is reconstructed based on the mark points of the rough image information, the first point cloud data is reconstructed based on the modulated reconstruction pattern of the rough image information, the three-dimensional data of the second mark point is reconstructed based on the mark points of the precise image information, the second point cloud data is reconstructed based on the modulated reconstruction pattern of the precise image information, the first transformation matrix is determined based on the splicing of multiple pieces of the three-dimensional data of the first mark point, multiple pieces of the first point cloud data are spliced based on the first transformation matrix, the second transformation matrix is determined based on the splicing of the three-dimensional data of the first mark point and the three-dimensional data of the second mark point, and the first point cloud data and the second point cloud data are spliced based on the second conversion matrix, so as to obtain the complete three-dimensional data of the scanned object.

In this embodiment, for the first point cloud data and the second point cloud data, whether the first point cloud data or the second point cloud data is retained or not may be selected according to the curvature, so as to achieve adaptive retention of feature details of the data, thereby reducing the data volume on the basis of ensuring the data details. For the part of the scanned object that does not require high details, the first point cloud data may be obtained by the first collecting apparatus through scanning, and for the part of the scanned object that requires high details, the second point cloud data may be obtained by the second collecting apparatus through scanning, and the first point cloud data and the second point cloud data are spliced to obtain the complete three-dimensional data of the scanned object. It can be seen that high-fidelity and high-detail data quality may be obtained while ensuring the data details, and the data volume is reduced.

In a third operating mode, the first illumination piece irradiates the light of the first waveband to the surface of the scanned object, the mark points are pasted on the surface of the scanned object, the light of the first waveband is reflected by the surface of the scanned object and collected by the external collecting component, and the external collecting component collects the rough image information including the mark points; the second illumination piece irradiates the light of the second waveband to the surface of the scanned object, the second projection module synchronously projects the reconstruction pattern of the second waveband to the surface of the scanned object relative to the second irradiation piece, the light and the reconstruction pattern of the second waveband are reflected by the surface of the scanned object and collected by the internal collecting component, and the internal collecting component synchronously collects the precise image information including the mark points and the modulated reconstruction pattern; and the complete three-dimensional data of the scanned object is obtained based on the collected rough image information and precise image information, specifically, the three-dimensional data of the first mark point is reconstructed based on the mark points of the rough image information, the three-dimensional data of the second mark point is reconstructed based on the mark points of the precise image information, the second point cloud data is reconstructed based on the modulated reconstruction pattern of the precise image information, the first transformation matrix is determined based on the splicing of multiple pieces of the three-dimensional data of the first mark point, and multiple pieces of second point cloud data are spliced based on the first transformation matrix, so as to obtain the complete three-dimensional data of the scanned object. In this way, the usage amount of the mark points on the scanned object may be reduced, holes in the second point cloud data may be reduced, and at the same time, the high details of the complete three-dimensional data of the scanned object may be ensured.

In a fourth operating mode, the first illumination piece irradiates the light of the first waveband to the surface of the scanned object in the first time period, the mark points are pasted on the surface of the scanned object, the light of the first waveband is reflected by the surface of the scanned object and collected by the external collecting component in the first time period, and the external collecting component collects the rough image information including the mark points; the second illumination piece irradiates the light of the second waveband to the surface of the scanned object in the second time period, the second projection module projects the reconstruction pattern of the second waveband to the surface of the scanned object in the second time period, the light and the reconstruction pattern of the second waveband are reflected by the surface of the scanned object and collected by the internal collecting component in the second time period, the first time period and the second time period are different time periods, and the internal collecting component collects the precise image information including the mark points and the modulated reconstruction pattern in a time-sharing manner relative to the external collecting component; and the complete three-dimensional data of the scanned object is obtained based on the collected rough image information and precise image information, specifically, the three-dimensional data of the first mark point is reconstructed based on the mark points of the rough image information, the three-dimensional data of the second mark point is reconstructed based on the mark points of the precise image information, the second point cloud data is reconstructed based on the modulated reconstruction pattern of the precise image information, the first transformation matrix is determined based on multiple pieces of the three-dimensional data of the first mark point, the second transformation matrix is determined based on the splicing of the three-dimensional data of the first mark point and the three-dimensional data of the second mark point, and multiple pieces of the second point cloud data are spliced based on the first transformation matrix and the second transformation matrix, so as to obtain the complete three-dimensional data of the scanned object.

In a fifth operating mode, the first illumination piece irradiates the light of the first waveband to the surface of the scanned object, the first projection module synchronously projects the reconstruction pattern of the first wavelength band to the surface of the scanned object relative to the first illumination piece, the mark points are pasted on the surface of the scanned object, the light and the reconstruction pattern of the first waveband is reflected by the surface of the scanned object and collected by the external collecting component, and the external collecting component collects the rough image information including the mark points and the modulated reconstruction pattern; the second projection module synchronously projects the reconstruction pattern of the second waveband to the surface of the scanned object relative to the second irradiation piece, the reconstruction pattern of the second waveband is modulated by the surface of the scanned object and collected by the internal collecting component, and the internal collecting component synchronously collects the precise image information including the modulated reconstruction pattern; and the complete three-dimensional data of the scanned object is obtained based on the collected rough image information and precise image information, specifically, the three-dimensional data of the first mark point is reconstructed based on the mark points of the rough image information, the first point cloud data is reconstructed based on the modulated reconstruction pattern of the rough image information, the second point cloud data is reconstructed based on the modulated reconstruction pattern of the precise image information, the first transformation matrix is determined based on the splicing of multiple pieces of the three-dimensional data of the first mark point, and the first point cloud data and the second point cloud data are spliced based on the first transformation matrix and the calibrated external parameters of the first collecting apparatus and the second collecting apparatus, so as to obtain the complete three-dimensional data of the scanned object. In this way, the usage amount of the mark points on the scanned object may be reduced, holes in the second point cloud data may be reduced, and at the same time, the high details of the complete three-dimensional data of the scanned object may be ensured.

In this embodiment, for the first point cloud data and the second point cloud data, whether the first point cloud data or the second point cloud data is retained or not may be selected according to the curvature, so as to achieve adaptive retention of feature details of the data, thereby reducing the data volume on the basis of ensuring the data details.

In a sixth operating mode, the first illumination piece irradiates the light of the first waveband to the surface of the scanned object, the mark points are pasted on the surface of the scanned object, the light of the first waveband is reflected by the surface of the scanned object and collected by the external collecting component, and the external collecting component collects the rough image information including the mark points; the second illumination piece synchronously projects the reconstruction pattern of the second waveband to the surface of the scanned object relative to the first irradiation piece, the reconstruction pattern of the second waveband is modulated by the surface of the scanned object and collected by the internal collecting component, and the internal collecting component synchronously collects the precise image information including the modulated reconstruction pattern relative to the external collecting component; and the complete three-dimensional data of the scanned object is obtained based on the collected rough image information and precise image information, specifically, the three-dimensional data of the first mark point is reconstructed based on the mark points of the rough image information, the second point cloud data is reconstructed based on the modulated reconstruction pattern of the precise image information, the first transformation matrix is determined based on the splicing of multiple pieces of the three-dimensional data of the first mark point, and multiple pieces of the second point cloud data are spliced based on the first transformation matrix, so as to obtain the complete three-dimensional data of the scanned object. In this way, the usage amount of the mark points on the scanned object may be reduced, holes in the second point cloud data may be reduced, and at the same time, the high details of the complete three-dimensional data of the scanned object may be ensured.

In an embodiment, the first collecting apparatus 210 includes multiple external collecting components, and the second collecting apparatus 220 includes at least one internal collecting component. The first collecting apparatus 210 further includes a first illumination piece of a first waveband and a first optical filter of the first waveband. The first illumination piece is annularly arranged around each external collecting component, and the first illumination piece is configured to project the light of the first waveband to illuminate the mark points on the surface of the scanned object 60, and the first optical filter is arranged at the front end of the external collecting component, and the first optical filter is configured to retain the incident light of the first waveband and filter out the incident light of other wavebands. The projection module 230 includes a projector of a second waveband for projecting the reconstruction pattern of the second waveband to the scanned object 60. The second collecting apparatus 220 includes a second optical filter of the second waveband. The second optical filter is arranged at the front end of the internal collecting component, and the second optical filter is configured to retain the incident light of the second waveband and filter out the incident light of other wavebands. In this embodiment, the first waveband is different from the second waveband.

The scanner of this embodiment is configured with the above sixth operating mode. During scanning, the scanner operates corresponding operating components or modules according to the operating mode.

In an embodiment, the first collecting apparatus 210 includes multiple external collecting components, and the second collecting apparatus 220 includes at least one internal collecting component. The projection module 230 includes a first projection module of a first waveband and a second projection module of a second waveband. The first projection module projects the reconstruction pattern of the first waveband to the scanned object 60, and the second projection module is configured to project the reconstruction pattern of the second waveband to the scanned object 60. The first collecting apparatus 210 further includes a first illumination piece of the first waveband. The first illumination piece is annularly arranged around each external collecting component, and the first illumination piece is configured to project the light of the first waveband to illuminate the mark points on the surface of the scanned object 60. The second collecting apparatus 220 further includes a second illumination piece of the second waveband. The second illumination piece is annularly arranged around each internal collecting component, and the second illumination piece is configured to project the light of the second waveband to illuminate the mark points on the surface of the scanned object 60. In this embodiment, the first waveband and the second waveband are the same waveband. The front end of the external collecting component and the front end of the internal collecting component may not be provided with the optical filter, or may be provided with the optical filter for the light of the first waveband (i.e., the second waveband) to pass through, and the optical filter is arranged to filter out the light of other wavebands according to the requirements. It is understandable that the projection module 230 may be provided with one projector, which is used as both the first projection module and the second projection module.

The scanner of this embodiment is configured with one or more of the above second, third, fourth and sixth operating modes. One of the configurations is selected for scanning according to the scanning requirements, and during scanning, the scanner operates corresponding operating components or modules according to the operating mode.

In an embodiment, the first collecting apparatus 210 includes multiple external collecting components, and the second collecting apparatus 220 includes at least one internal collecting component. The projection module 230 includes a first projection module of a first waveband and a second projection module of a second waveband. The first projection module projects the reconstruction pattern of the first waveband to the scanned object 60, and the second projection module is configured to project the reconstruction pattern of the second waveband to the scanned object 60. The first collecting apparatus 210 further includes a first illumination piece of the first waveband. The first illumination piece is annularly arranged around each external collecting component, and the first illumination piece is configured to project the light of the first waveband to illuminate the mark points on the surface of the scanned object 60. The second collecting apparatus 220 further includes a second illumination piece of the second waveband. The second illumination piece is annularly arranged around each internal collecting component, and the second illumination piece is configured to project the light of the second waveband to illuminate the mark points on the surface of the scanned object 60. In this embodiment, the first waveband is different from the second waveband. The front end of the external collecting component and the front end of the internal collecting component may not be provided with the optical filter, or may be provided with the optical filter for the light of the first waveband and the second waveband to pass through, and the optical filter is arranged to filter out the light of other wavebands according to the requirements. It is understandable that the projection module may also be a dual-frequency projector, which is controlled to alternately project the reconstruction pattern of the first waveband and the reconstruction pattern of the second waveband.

The scanner of this embodiment is configured with one or two of the above second, third, fourth and sixth operating modes. One of the configurations is selected for scanning according to the scanning requirements, and during scanning, the scanner operates corresponding operating components or modules according to the operating mode.

In an embodiment, the first collecting apparatus 210 includes multiple external collecting components, and the second collecting apparatus 220 includes at least one internal collecting component. The first collecting apparatus 210 further includes a first illumination piece of a first waveband. The first illumination piece is annularly arranged around each external collecting component, and the first illumination piece is configured to project the light of the first waveband to illuminate the mark points on the surface of the scanned object 60. The second collecting apparatus 220 further includes a second illumination piece of a second waveband. The second illumination piece is annularly arranged around the internal collecting component, and the second illumination piece is configured to project the light of the second waveband to illuminate the mark points on the surface of the scanned object 60. In this embodiment, the first waveband is different from the second waveband. The projection module includes a projector, which may be used as the first projection module to project the reconstruction pattern of the first waveband to the scanned object 60, or as the second projection module to project the reconstruction pattern of the second waveband to the scanned object 60. The front end of the external collecting component and the front end of the internal collecting component may not be provided with the optical filter, or may be provided with the optical filter for the light of the first waveband and the second waveband to pass through, and the optical filter is arranged to filter out the light of other wavebands according to the requirements.

The scanner of this embodiment is configured with one or two of the above second, third, fourth and sixth operating modes. One of the configurations is selected for scanning according to the scanning requirements, and during scanning, the scanner operates corresponding operating components or modules according to the operating mode.

In an embodiment, the first collecting apparatus 210 includes multiple external collecting components, and the second collecting apparatus 220 includes at least one internal collecting component. The first collecting apparatus 210 includes a first illumination piece and a first optical filter of a first waveband. The first illumination piece is annularly arranged around each external collecting component, and the first illumination piece is configured to illuminate the mark points on the surface of the scanned object, and the first optical filter is arranged at the front end of the external collecting component, and the first optical filter is configured to retain the incident light of the first waveband and filter out the incident light of other wavebands. The second collecting apparatus includes a second illumination piece and a second optical filter of a second waveband. The second illumination piece is annularly arranged around each internal collecting component, and the second illumination piece is configured to illuminate the mark points on the surface of the scanned object, and the second optical filter is arranged at the front end of the internal collecting component, and the second optical filter is configured to retain the incident light of the second waveband and filter out the incident light of other wavebands. The projection module includes a second projection module. The second projection module is configured to project the reconstruction pattern of the second waveband to the scanned object. In this embodiment, the first waveband is different from the second waveband.

The scanner of this embodiment is configured with one or more of the above third, fourth and sixth operating modes. One of the configurations is selected for scanning according to the scanning requirements, and during scanning, the scanner operates corresponding operating components or modules according to the operating mode.

In an embodiment, the first collecting apparatus 210 includes multiple external collecting components, and the second collecting apparatus 220 includes at least one internal collecting component. The first collecting apparatus includes a first illumination piece and a first optical filter of a first waveband. The first illumination piece is annularly arranged around each external collecting component, and the first illumination piece is configured to illuminate the mark points on the surface of the scanned object. The first optical filter is arranged at the front end of the external collecting component, and the first optical filter is configured to retain the incident light of the first waveband and filter out the incident light of other wavebands. The second collecting apparatus includes a second optical filter. The second optical filter is arranged at the front end of the internal collecting component, and the second optical filter is configured to retain the incident light of the second waveband and filter out the incident light of other wavebands. The projection module includes a first projection module and a second projection module. The first projection module is configured to project the reconstruction pattern of the first waveband to the scanned object. The second projection module is configured to project the reconstruction pattern of the second waveband to the scanned object. In this embodiment, the first waveband is different from the second waveband.

The scanner of this embodiment is configured with one or two of the above fifth and sixth operating modes. One of the configurations is selected for scanning according to the scanning requirements, and during scanning, the scanner operates corresponding operating components or modules according to the operating mode.

Multiple first illumination pieces may be arranged around each external collecting component, and the specific number thereof is not limited in this embodiment. Both the first illumination piece and the second illumination piece may be Light Emitting Diode (LED) lights. The illumination pieces are annularly arranged around the camera to scan the mark points in multiple directions, and the scanned object 60 is scanned more comprehensively, thereby improving the scanning accuracy.

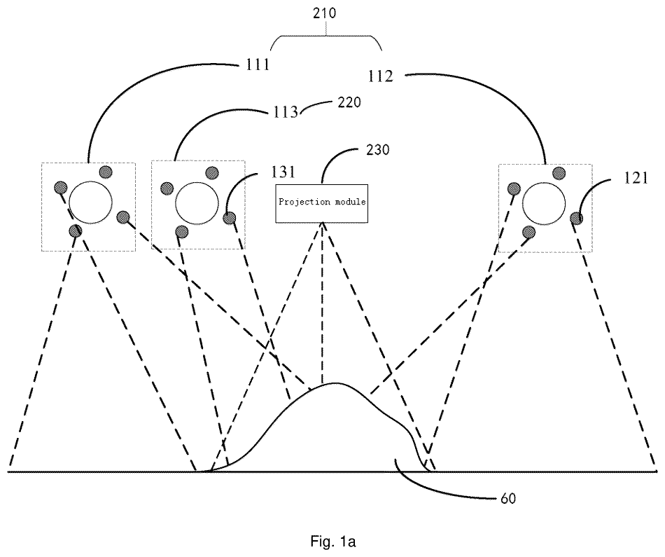

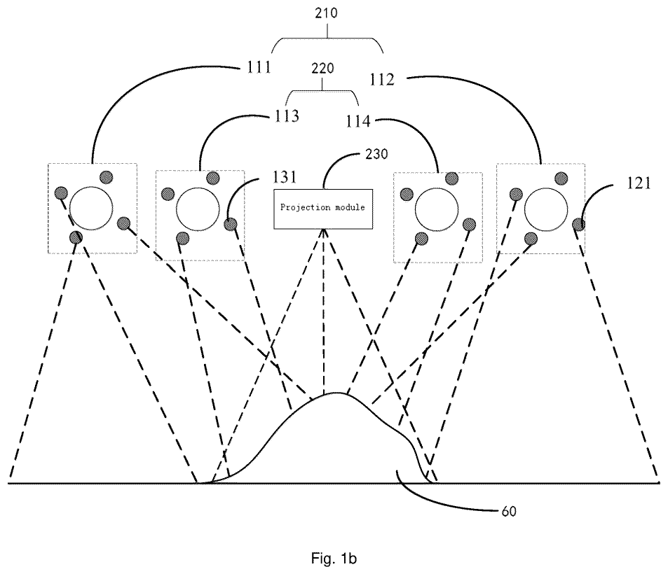

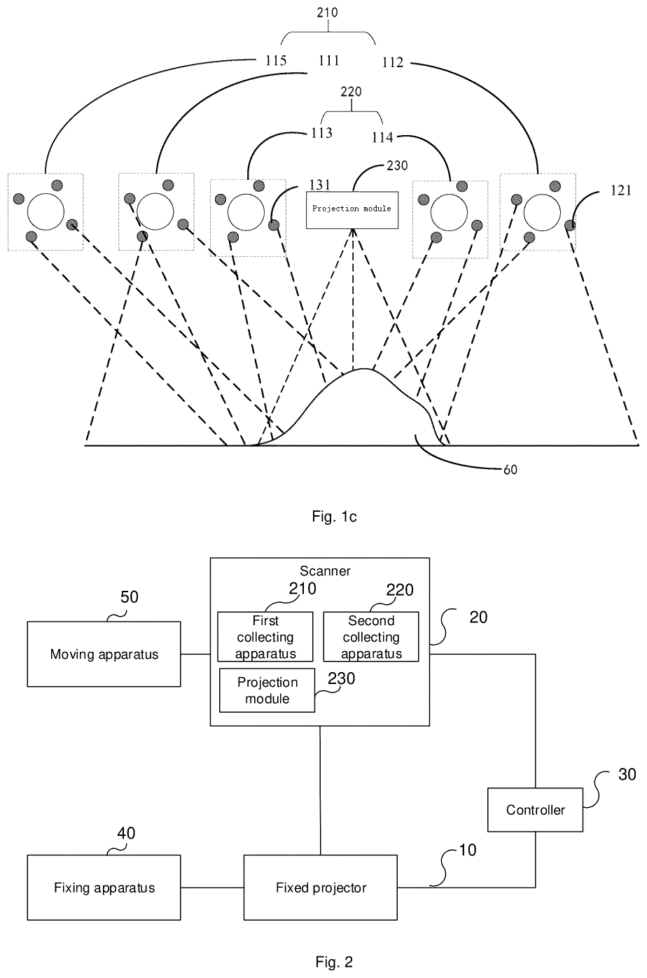

As shown in FIG. 1a, the first collecting apparatus 210 includes two cameras, namely a first collecting component and a second collecting component, which construct a binocular reconstruction system, and the second collecting apparatus 220 includes a third collecting component, which constructs a monocular reconstruction system. The third collecting component is arranged between the first collecting component and the second collecting component. The projection module 230 may be arranged between the third collecting component and the first collecting component, and the projection module 230 may also be arranged between the third collecting component and the second collecting component.

In an embodiment, as shown in FIG. 1b, the first collecting apparatus 210 includes a first collecting component and a second collecting component, which construct a binocular reconstruction system, and the second collecting apparatus 220 includes a third collecting component and a fourth collecting component, which construct a binocular reconstruction system. The third collecting component and the fourth collecting component are both arranged between the first collecting component and the second collecting component, that is, the first collecting component and the second collecting component are located outside the scanner, and the third collecting component and the fourth collecting component are both located inside the scanner. The projection module 230 is arranged between the third collecting component and the fourth collecting component, that is, the projection module 230 is located in the middle, so that the projected reconstruction pattern may be distributed more evenly and the scanning accuracy may be improved.

In an embodiment, as shown in FIG. 1c, the first collecting apparatus 210 includes a first collecting component, a second collecting component, and a fifth collecting component. Any two of the first collecting component, the second collecting component, and the fifth collecting component may construct a binocular reconstruction system. For example, the first collecting component and the second collecting component may construct the binocular reconstruction system, or the second collecting component and the fifth collecting component may construct the binocular reconstruction system, and during the scanning process, the three cameras may be switched to construct the binocular reconstruction system. The second collecting apparatus 220 includes a third collecting component and a fourth collecting component, which construct a binocular reconstruction system.

It is understandable that the projection module 230 may also be arranged at other positions. The arrangement position of the projection module 230 in the above embodiments is an example and does not limit the specific arrangement position of the projection module 230.

The scanner provided by the embodiment of the present disclosure includes the projection module 230, the first collecting apparatus 210, and the second collecting apparatus 220. The projection module 230 projects the reconstruction pattern to the scanned object 60. The second collecting apparatus 220 is arranged to be within the second scanning range, and the second collecting apparatus is configured to collect the precise image information based on the reconstruction pattern reflected by the scanned object 60. The first collecting apparatus 210 is arranged to be within the first scanning range, which is larger than the second scanning range, and collect the rough image information of the surface of the scanned object 60, so as to obtain the complete three-dimensional data of the scanned object according to the rough image information and the precise image information. According to the present disclosure, multiple pieces of the point cloud data are obtained through the precise image information of the scanned object 60 collected by the second collecting apparatus 220, and the three-dimensional data of the mark points is obtained through the rough image information collected by the first collecting apparatus 210. Since the scanning range of the first collecting apparatus 210 is larger than that of the second collecting apparatus 220 and the scanning ranges overlap, the single three-dimensional data of the mark point may correspond to multiple pieces of the point cloud data, so as to determine the positional relationship between multiple pieces of the point cloud data, thereby achieving the splicing of multiple pieces of the point cloud data. For the same camera, when an image of a larger scene is collected, the details of the collected image are relatively poor. Conversely, when an image with better details is collected, the scene of the collected image is small. In the present disclosure, the first collecting apparatus is configured to collect the mark points on the surface of the scanned object, and the second collecting apparatus is configured to collect the reconstruction pattern modulated by the scanned object to obtain the point cloud data with better details. Since the scanning range outside the first collecting apparatus is larger, relatively scattered mark points may be pasted on the surface of the scanned object, that is, the splicing of the point cloud data may be completed in a case of reducing the usage amount of the mark points. The scanning range of the second collecting apparatus is smaller but the data details are better, so that the present disclosure may ensure the details of the scanned data and improve the scanning accuracy in a case of reducing the usage amount of the mark points. Of course, the first collecting apparatus may also be configured for other collections and is not limited to the collection of the mark points, and the second collecting apparatus may also be used for other collections and is not limited to the collection of the reconstruction pattern.

Optionally, the three-dimensional data of the key features and the dense three-dimensional point cloud data which are synchronously collected by the first collecting apparatus 210 and the second collecting apparatus 220 are unified into single data in the same coordinate system, thereby improving the data processing efficiency of the scanner 20 and increasing the speed for the subsequent establishment of the three-dimensional model of the scanned object. Optionally, the three-dimensional data of the key features and the dense three-dimensional point cloud data collected by the first collecting apparatus 210 and the second collecting apparatus 220 at the same time sequence are unified into single data in the same coordinate system. In actual operations, the first collecting apparatus 210 and the second collecting apparatus 220 may generate a certain error, and the controller 30 sorts the three-dimensional data of the key features and the dense three-dimensional point cloud data to obtain the three-dimensional data with higher accuracy.

In some embodiments, the first collecting apparatus 210 further includes the first illumination piece and the first optical filter of the first waveband. The first illumination piece is annularly arranged around each external collecting component, and the first illumination piece is configured to project the light of the first waveband to illuminate the mark points on the surface of the scanned object. The first optical filter is arranged at the front end of the external collecting component, and the first optical filter is configured to retain the incident light of the first waveband and filter out the incident light of other wavebands. The second collecting apparatus 220 includes the second optical filter of the second waveband. The second optical filter is arranged at the front end of the internal collecting component, and the second optical filter is configured to retain the incident light of the second waveband and filter out the incident light of other wavebands. The first waveband is different from the second waveband.

The first collecting apparatus 210 is configured to collect the mark points of the first waveband of the scanned object. The second collecting apparatus 220 is configured to synchronously collect the mark points and the modulated reconstruction pattern of the second waveband of the scanned object.

In some embodiments, the scanner further includes a housing, in which the projection module, the first collecting apparatus, and the second collecting apparatus are arranged in the housing, and the scanner further includes a gripping part arranged on the scanner.

In some embodiments, before the scanner 20 leaves the factory, the coordinate systems of the first collecting apparatus 210 and the second collecting apparatus 220 are unified. Further, before the scanner 20 collects the three-dimensional data of the key features and the dense three-dimensional point cloud data, the coordinate systems of the first collecting apparatus 210 and the second collecting apparatus 220 are unified, so that the three-dimensional data of the key features and the dense three-dimensional point cloud data synchronously collected are easily unified into single data in the same coordinate system.

Optionally, the collecting range of the first collecting apparatus 210 at least partially overlaps with the collecting range of the second collecting apparatus 220. Optionally, the synchronous collecting ranges of the first collecting apparatus and the second collecting apparatus are the same or nearly the same, so that the three-dimensional data of the key features and the dense three-dimensional point cloud data synchronously collected are easily unified into single data in the same coordinate system, so as to obtain the three-dimensional data with higher accuracy.

The three-dimensional scanning system further includes a moving apparatus 50, and the scanner 20 is arranged on the moving apparatus 50. The moving apparatus 50 can drive the scanner 20 to move relative to the scanned object 60, so that the scanner 20 collects the feature image of each surface of the scanned object 60 and reflected scanning light in multiple angles.

The controller 30 is in communication connection with the scanner 20, and the controller is configured to establish the three-dimensional model of the scanned object 60 according to the three-dimensional point cloud data of the scanned object. The communication connection includes any one of a wired connection and a wireless connection. The controller may be an independent device or may be integrated with the scanner. In some embodiments, the controller 30 is integrated in the scanner 20. In another embodiment, the controller 30 is an independent device which is in communication connection with the projector 10 and the scanner 20, receives the three-dimensional point cloud data collected by the scanner 20, and controls the projector 10 and the scanner 20.

The controller 30 is in communication connection with the projector 10, and the controller 30 controls the projector 10 to project the corresponding feature image according to the scanning requirements.

Optionally, the controller 30 controls the projection light intensity of the projector 10 and the image types of the key features in the feature image according to the scanning requirements. Specifically, the image types include a cross line, a circle, or other images that may be projected to the surface of the scanned object to collect the three-dimensional data of the key features. In some embodiments, the image type is the cross line, and the cross line may enable the first collecting apparatus 210 to collect the three-dimensional data of the key features more accurately.

The controller 30 obtains the three-dimensional data of the key features and the dense three-dimensional point cloud data collected by the scanner 20, processes the three-dimensional data of the key features and the dense three-dimensional point cloud data synchronously collected to obtain single data, and establishes the three-dimensional model of the scanned object 60 according to multiple pieces of the single data.

The present disclosure provides the three-dimensional scanning system, which includes a processing apparatus and the scanner of any of the above embodiments. The processing apparatus is respectively connected to the first collecting apparatus 210 and the second collecting apparatus 220 in the scanner, and the processing apparatus is configured to obtain the rough image information and the precise image information of the scanned object, and process the rough image information and the precise image information to obtain the complete three-dimensional data of the scanned object. Specifically, after the rough image information and the precise image information are obtained, multiple pieces of the point cloud data corresponding to the precise image information are extracted, and the splicing of multiple pieces of the point cloud data is achieved according to the rough image information, thereby completing the accurate splicing of the scanned object 60, and obtaining the complete three-dimensional data of the scanned object 60.

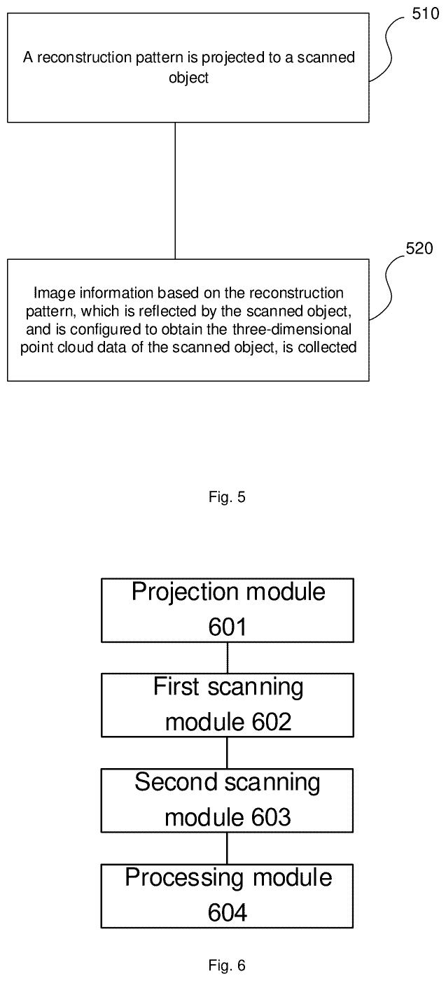

FIG. 5 is a flowchart a three-dimensional scanning method according to an embodiment of the present disclosure. As shown in FIG. 5, the method may include the following processing steps.

At S510, a reconstruction pattern is projected to a scanned object.

In this embodiment, the reconstruction pattern may be projected to the scanned object 60 by a projection module 230 in a scanning device. Before the scanning device (a scanner or a three-dimensional scanning system) operates, calibration is needed, that is, cameras in a first collecting apparatus 210 and a second collecting apparatus 220 are calibrated to obtain calibration parameters. Specifically, an internal collecting component in the second collecting apparatus 220 and an external collecting component in the first collecting apparatus 210 are calibrated to obtain internal and external parameters of multiple cameras and rotation and translation matrices corresponding to relative positions between multiple cameras, and the calibrated scanning device may further obtain the complete three-dimensional data of the scanned object 60 according to obtained image information.

It is to be noted that when the first collecting apparatus 210 and the second collecting apparatus 220 simultaneously collect mark points of the scanned object 60, the relative positions of the internal collecting component and the external collecting component may not be calibrated, and only the internal and external parameters of multiple cameras, and the relative positions of the projection module, the internal collecting component, and the external collecting component need to be calibrated. After obtaining mark point information and a modulated reconstruction pattern, a processing module only needs to process according to the internal and external parameters of the camera, and relative position parameters of a projection apparatus, the internal collecting component, and the external collecting component, and does not need to consider the relative position parameters of the internal collecting component and the external collecting component, thereby reducing the processing complexity and improving the speed of three-dimensional scanning.

Before scanning, the mark points need to be pasted on the scanned object 60, and the mark points may be spread over an outer surface of the scanned object 60 as reference points. There may be multiple mark points, and the specific number and arrangement positions are not limited in this embodiment, but it is necessary to ensure that all mark points are not on the same straight line. Preferably, any three mark points are not on the same straight line, so that point cloud data may be spliced more accurately.

The mark point may be made of a reflective material with higher reflective performance, and the mark point is pasted on the outer surface of the scanned object 60. Light of a preset waveband is projected to the scanned object 60 by an illumination piece. The above first waveband and second waveband are both preset wavebands. The spectrum of the light of the preset waveband is not limited. Preferably, the light of the preset waveband is one of three monochromatic lights of red, blue, and green.

The reconstruction pattern projected by the projection module 230 is not limited, and may be a common stripe pattern, a speckle pattern, a sinusoidal stripe pattern, etc. Preferably, the reconstruction pattern is a common stripe pattern, and the number of stripes is not limited, but in order to improve the scanning efficiency, more than 15 stripes are usually required. It is understandable that when the number of stripes is small, the reconstruction pattern is sparse, data obtained by a single scan is small, and more data information of the scanned object 60 may be obtained through multiple scans; and when the number of stripes is large, the reconstruction pattern is dense, and more data information of the scanned object 60 may be obtained by a single scan.

The structure of the projection module 230 is not limited, as long as it can project the reconstruction pattern to the scanned object 60. Preferably, the projection module 230 may include a laser and/or a projector.

At S520, image information reflected by the scanned object is collected, the image information is obtained based on the reconstruction pattern, the image information is used for obtaining the three-dimensional point cloud data of the scanned object.

In this embodiment, the processing apparatus may obtain rough image information and precise image information of the scanned object 60, and process the rough image information and the precise image information to obtain the complete three-dimensional data of the scanned object 60. The processing apparatus may obtain the rough image information collected by the first collecting apparatus 210 and the precise image information collected by the second collecting apparatus 220 through a data interface, and then perform processing such as reconstruction, splicing, and fusion on the rough image information and the precise image information to obtain the complete three-dimensional data of the scanned object 60.

The processing apparatus may be a Central Processing Unit (CPU). It is understandable that the processing apparatus is further configured to control operating states of the projection module 230, the first collecting apparatus 210, and the second collecting apparatus 220. Specifically, the processing apparatus may send a control instruction to control the projection module 230 to project the reconstruction pattern and control the number of projected reconstruction patterns, etc. The processing apparatus may send a control instruction to control the exposure time of the first collecting apparatus 210 and the second collecting apparatus 220 to collect the rough image information and the precise image information. The data interface receives the image information and sends same to the CPU.

Optionally, S510 that the reconstruction pattern is projected to the scanned object includes the following operations.

A feature image of the first waveband is projected to the scanned object. The feature image includes multiple key features.

Scanning light of the second waveband is emitted to a surface of the scanned object, where the second waveband is different from the first waveband.

The projector projects the feature image of the first waveband to the scanned object 60. The first waveband may be any one of a visible light waveband and an invisible light waveband. As one optional example, the first waveband is a waveband of 815 nm to 845 nm in the invisible light waveband. Further, the feature image of the first waveband adopts a specific wavelength, and the wavelength is 830 nm.

The projection module 230 in the scanner 20 emits the scanning light of the second waveband to the surface of the scanned object 60. The second waveband may be any one of a visible light waveband and an invisible light waveband. As one optional example, the second waveband is a waveband of 440 nm to 470 nm in the visible light waveband. Further, the scanning light of the second waveband adopts a specific wavelength, and the wavelength is 455 nm.

The first waveband projected by the projector and the second waveband emitted by the projection module 230 of the scanner are different. The feature image of the first waveband collected by the scanner 20 and the scanning light reflected by the second waveband are less likely to interfere with each other, so that the collected three-dimensional data is more accurate.

Optionally, S520 that the image information reflected by the scanned object is collected, the image information is obtained based on the reconstruction pattern, the image information is used for obtaining the three-dimensional point cloud data of the scanned object, includes the following operations.

The feature image projected to the scanned object is collected, and the three-dimensional data of key features projected to the surface of the scanned object is obtained.

The scanning light of the second waveband reflected by the scanned object is collected, and the dense three-dimensional point cloud data of the surface of the scanned object is obtained.

The first collecting apparatus 210 in the scanner 20 collects the feature image projected to the scanned object 60, obtains the three-dimensional data of the key features projected to the surface of the scanned object 60, and sends the collected three-dimensional data to a controller 30.

The second collecting apparatus 220 in the scanner 20 collects the scanning light of the second waveband reflected by the scanned object 60, obtains the dense three-dimensional point cloud data of the scanned object 60, and sends the collected dense three-dimensional point cloud data to the controller 30.

Optionally, the three-dimensional data of the key features and the dense three-dimensional point cloud data are synchronously collected, the three-dimensional data of the key features and the dense three-dimensional point cloud data synchronously collected are unified into single data in the same coordinate system, and the controller 30 establishes a three-dimensional model of the scanned object according to multiple pieces of the single data.

Optionally, the three-dimensional scanning method further includes: performing rigid body transformation on common key features among multiple pieces of the single data, and splicing residuals and performing non-linear least square method iterative optimization to complete a high accuracy of global optimization and reduce an accumulated error of multiple pieces of the single data.

The three-dimensional scanning method further includes: performing joint weighted optimization between the three-dimensional data of the key features and the dense three-dimensional point cloud data through an Iterative Closest Point (ICP) algorithm.

After the step of performing jointed weighted optimization between the three-dimensional data of the key features and the dense three-dimensional point cloud data through the ICP algorithm, the method further includes: fusing multiple pieces of the single data after data optimization into an overall point cloud through a Fusion algorithm, and converting the overall point cloud into an overall surface patch through triangulation.

The controller 30 performs rigid body transformation on common key features among multiple pieces of the single data, the residuals are spliced, and non-linear least square method iterative optimization is performed to complete a high accuracy of global optimization and reduce an accumulated error of multiple pieces of the single data. Multiple pieces of the single data after splicing are fused into the overall point cloud through the Fusion algorithm, the overall point cloud is converted into the overall surface patch through triangulation, and then, the three-dimensional model of the scanned object is established.

According to the present disclosure, the rough image information of the scanned object collected by the external collecting component is used to assist in the splicing of the point cloud data corresponding to the precise image information, so that the complete three-dimensional data of the scanned object is obtained, and in a case of reducing the usage amount of the mark points, holes that need to be filled later in the point cloud data may be reduced or even eliminated, the details of the scanned data are ensured, and the scanning accuracy is improved.

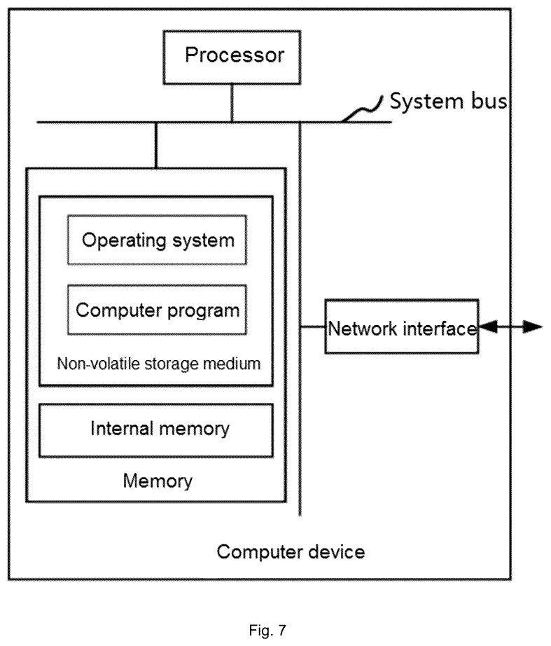

In one embodiment, a computer device is provided. The computer device may be a terminal, and a structural diagram thereof may be shown in FIG. 7. The computer device includes a processor, a memory, a network interface, a display screen, and an input apparatus which are connected through a system bus. The processor of the computer device is configured to provide computing and control capabilities. The memory of the computer device includes a non-volatile storage medium and an internal memory. The non-volatile storage medium stores an operating system and a computer program. The internal memory provides an environment for the operation of an operating system and the computer program in the non-volatile storage medium. The network interface of the computer device is configured to communicate with an external terminal through a network connection. The computer program is executed by the processor to implement a three-dimensional scanning method. The display screen of the computer device may be a liquid crystal display screen or an electronic ink display screen, and the input apparatus of the computer device may be a touch layer covering the display screen, or a key, a trackball or a touchpad provided on a housing of the computer device, or an external keyboard, touchpad or mouse, etc.

Those skilled in the art may understand that the structure shown in FIG. 7 is a block diagram of a partial structure related to the solution of the present disclosure, and does not constitute a limitation on the computer device to which the solution of the present disclosure is applied. The specific computer device may include more or fewer components than shown in the figure, or combine certain components, or have a different arrangement of components.

The technical features of the above-described embodiments may be arbitrarily combined. For the sake of brevity of description, all possible combinations of the technical features in the above embodiments are not described. However, as long as there is no contradiction between the combinations of these technical features, all should be considered as the scope of this description.

The above embodiments are illustrative of several implementations of the present disclosure with specific and detailed description, and are not to be construed as limiting the patent scope of the present disclosure. It is to be noted that a number of variations and modifications may be made by those of ordinary skill in the art without departing from the conception of the present disclosure, and all fall within the scope of protection of the present disclosure. Therefore, the scope of protection of the present disclosure should be determined by the appended claims.

1. A three-dimensional scanning system, configured to obtain three-dimensional data of a scanned object, wherein the three-dimensional scanning system comprises:
a scanner, comprising a projection module and a collecting module, wherein the projection module is configured to project scanning light to the scanned object, and the collecting module comprises a first collecting apparatus and a second collecting apparatus, the first collecting apparatus is configured to obtain three-dimensional data of features of a surface of the scanned object, the second collecting apparatus is configured to obtain three-dimensional point cloud data of the surface of the scanned object, and the three-dimensional data of the features comprises: three-dimensional data of mark points and three-dimensional data of key features, or three-dimensional data of mark points, or three-dimensional data of key features.

2. The three-dimensional scanning system as claimed in claim 1, wherein the first collecting apparatus is arranged for collecting rough image information of the surface of the scanned object within a first scanning range, the second collecting apparatus is arranged for collecting precise image information based on a reconstructed pattern reflected by the scanned object within a second scanning range, the rough image information is configured to determine three-dimensional data of mark points, the precise image information is configured to determine point cloud data, and a plurality of pieces of the point cloud data are spliced based on the three-dimensional data of the mark points to obtain complete three-dimensional data of the scanned object.

3. The three-dimensional scanning system as claimed in claim 1, further comprising at least one fixed projector, configured to be fixed to a preset position relative to the scanned object, wherein the scanner is configured to be movable relative to the scanned object, the fixed projector is configured to project a feature image of a first waveband to the scanned object, the projection module is configured to emit scanning light of a second waveband to the surface of the scanned object, the feature image comprises a plurality of key features, the first collecting apparatus is configured to collect the feature image projected to the scanned object, and obtain the three-dimensional data of the key features projected to the surface of the scanned object, and the second collecting apparatus is configured to collect the scanning light of the second waveband reflected by the scanned object, and obtain dense three-dimensional point cloud data of the surface of the scanned object, wherein the first waveband does not interfere with the second waveband.

4. The three-dimensional scanning system as claimed in claim 2, wherein the second scanning range is smaller than the first scanning range.

5. The three-dimensional scanning system as claimed in claim 1, wherein a collecting range of the first collecting apparatus at least partially overlaps with a collecting range of the second collecting apparatus.

6. The three-dimensional scanning system as claimed in claim 1, wherein the scanner comprises a housing, the projection module, the first collecting apparatus and the second collecting apparatus are arranged in the housing, and the scanner further comprises a gripping part arranged on the scanner.

7. The three-dimensional scanning system as claimed in claim 1, wherein the first collecting apparatus further comprises a first illumination piece and a first optical filter of a first waveband, wherein the first illumination piece is annularly arranged around each external collecting component, and the first illumination piece is configured to project light of the first waveband to illuminate mark points on the surface of the scanned object, and the first optical filter is arranged at a front end of the external collecting component, and the first optical filter is configured to retain incident light of the first waveband and filter out the incident light of other wavebands;
the second collecting apparatus comprises a second optical filter of a second waveband, wherein the second optical filter is arranged at a front end of an internal collecting component, and the second optical filter is configured to retain incident light of the second waveband and filter out the incident light of other wavebands, and the first waveband is different from the second waveband.

8. The three-dimensional scanning system as claimed in claim 6, wherein the projection module comprises a first projection module and a second projection module, the first projection module is configured to project a reconstruction pattern of a first waveband, the second projection module is configured to project a reconstruction pattern of a second waveband, the first collecting apparatus further comprises a first illumination piece and a first optical filter of the first waveband, the first illumination piece is annularly arranged around each external collecting component, and the first illumination piece is configured to project light of the first waveband to illuminate the mark points on the surface of the scanned object, and the first optical filter is arranged at a front end of the external collecting component, and the first optical filter is configured to retain incident light of the first waveband and filter out the incident light of other wavebands;
the second collecting apparatus further comprises a second illumination piece and a second optical filter of a second waveband, wherein the second illumination piece is annularly arranged around an internal collecting component, the second illumination piece is configured to project light of the second waveband to illuminate the mark points on the surface of the scanned object, the second optical filter is arranged at a front end of the internal collecting component, and the second optical filter is configured to retain incident light of the second waveband and filter out the incident light of other wavebands;
the first collecting apparatus is configured to collect the mark points and a modulated reconstruction pattern of the first waveband of the scanned object;
the second collecting apparatus is configured to collect the mark points and a modulated reconstruction pattern of the second waveband of the scanned object.

9. The three-dimensional scanning system as claimed in claim 6, wherein the projection module comprises a first projection module and a second projection module, the first projection module is configured to project a reconstruction pattern of a first waveband to the scanned object in a first time period, the second projection module is configured to project a reconstruction pattern of a second waveband to the scanned object in a second time period, a scanner body further comprises a first illumination piece and a second illumination piece, the first illumination piece is annularly arranged around each external collecting component, the second illumination piece is annularly arranged around an internal collecting component, and the first illumination piece and the second illumination piece are configured to illuminate mark points on the surface of the scanned object;
the first collecting apparatus is configured to collect the mark points and a modulated reconstruction pattern of the scanned object in the first time period;
the second collecting apparatus is configured to collect the mark points and the modulated reconstruction pattern of the scanned object in the second time period.

10. The three-dimensional scanning system as claimed in claim 2, wherein the projection module comprises a dual-frequency projector, the dual-frequency projector is configured to project a reconstruction pattern of a first waveband in a first time period, and the dual-frequency projector is configured to project a reconstruction pattern of a second waveband in a second time period, a scanner body further comprises a first illumination piece and a second illumination piece, the first illumination piece is annularly arranged around each external collecting component, the second illumination piece is annularly arranged around an internal collecting component, and the first illumination piece and the second illumination piece are configured to illuminate mark points on the surface of the scanned object;
the first collecting apparatus is configured to collect the mark points and a modulation reconstruction pattern of the scanned object in the first time period;
the second collecting apparatus is configured to collect the mark points and the modulated reconstruction pattern of the scanned object in the second time period.

11. The three-dimensional scanning system as claimed in claim 6, wherein the projection module comprises a projector, the projector is configured to project a reconstruction pattern to the scanned object in a second time period, a scanner body further comprises a first illumination piece and a second illumination piece, the first illumination piece is annularly arranged around each external collecting component, the first illumination piece is configured to project light to the scanned object in a first time period to illuminate mark points on the surface of the scanned object, the second illumination piece is annularly arranged around an internal collecting component, and the second illumination piece is configured to project light to the scanned object in the second time period to illuminate the mark points on the surface of the scanned object;
the first collecting apparatus is configured to collect the mark points of the scanned object in the first time period;
the second collecting apparatus is configured to collect the mark points and a modulated reconstruction pattern of the scanned object in the second time period.

12. The three-dimensional scanning system as claimed in claim 1, wherein the first collecting apparatus comprises a first collecting component and a second collecting component, the second collecting apparatus comprises a third collecting component, the third collecting component is arranged between the first collecting component and the second collecting component; the projection module is arranged between the third collecting component and the first collecting component, or the projection module is arranged between the third collecting component and the second collecting component.

13. The three-dimensional scanning system as claimed in claim 1, wherein the first collecting apparatus comprises a first collecting component and a second collecting component, and the second collecting apparatus comprises a third collecting component and a fourth collecting component, the third collecting component and the fourth collecting component are both arranged between the first collecting component and the second collecting component, and the projection module is arranged between the third collecting component and fourth collecting component.

14. The three-dimensional scanning system as claimed in claim 3, wherein the three-dimensional data of the key features and the dense three-dimensional point cloud data synchronously collected by the first collecting apparatus and the second collecting apparatus are unified into single data in the same coordinate system.

15. The three-dimensional scanning system as claimed in claim 3, wherein the three-dimensional scanning system comprises a plurality of fixed projectors, and the plurality of fixed projectors are arranged at intervals in a predetermined manner.

16. A three-dimensional scanning method, configured to obtain three-dimensional data of a scanned object and applied to the three-dimensional scanning system as claimed in claim 1, the three-dimensional scanning method comprising:
projecting a reconstruction pattern to the scanned object;
collecting image information reflected by the scanned object, wherein the image information is obtained based on the reconstruction pattern, the image information is used for obtaining the three-dimensional point cloud data of the scanned object.

17. The dimensional scanning method as claimed in claim 16, wherein projecting the reconstruction pattern to the scanned object comprises:
projecting a feature image of a first waveband to the scanned object, wherein the feature image comprises a plurality of key features;
emitting scanning light of a second waveband to a surface of the scanned object, wherein the second waveband is different from the first waveband.

18. The dimensional scanning method as claimed in claim 16, wherein collecting the image information based on the reconstruction pattern, which is reflected by the scanned object, and the image information is configured to obtain the three-dimensional point cloud data of the scanned object comprises:
collecting the feature image projected to the scanned object, and obtain the three-dimensional data of key features projected to the surface of the scanned object;
collecting the scanning light of the second waveband reflected by the scanned object, and obtaining dense three-dimensional point cloud data of the surface of the scanned object.

19. The three-dimensional scanning method as claimed in claim 16, wherein the three-dimensional data of the key features and the dense three-dimensional point cloud data are synchronously collected, the three-dimensional data of the key features and the dense three-dimensional point cloud data synchronously collected are unified into single data in the same coordinate system, and a three-dimensional model of the scanned object is established based on pieces of the single data.

20. The three-dimensional scanning method as claimed in claim 19, comprising:
performing rigid body transformation on common key features among the pieces of the single data, and splicing residuals and performing non-linear least square method iterative optimization to complete a high accuracy of global optimization and reduce an accumulated error of the pieces of the single data.
